(19) United States
(12) Patent Application Publication
(10) Pub. No.: US 2016/0253856 A1
(43) Pub. Date: Sep. 1, 2016

(54) COIN RECOGNITION AND REMOVAL FROM A MATERIAL STREAM

(71) Applicant: Strategic Materials, Inc., Houston, TX (US)

(72) Inventors: Erik William Foucha, Houston, TX (US); David Anthony Loulis, Houston, TX (US)

(21) Appl. No.: 15/056,799

(22) Filed: Feb. 29, 2016

Related U.S. Application Data
(60) Provisional application No. 62/126,023, filed on Feb. 27, 2015.

(51) Int. Cl. G07D 3/14; B07C 5/344; B07C 5/342

(52) U.S. Cl. CPC G07D 3/14; B07C 5/342; B07C 5/344

(57) ABSTRACT

The automated process, system and apparatus disclosed recognizes, and pulls or removes coins and/or currency from a stream of refuse and/or recycle material, such as, “3 mix” material (trash with heavy glass content).

### STATEMENTS REGARDING FEDERALLY SPONSORED RESEARCH OR DEVELOPMENT

Not Applicable.

### NAMES OF THE PARTIES TO A JOINT RESEARCH AGREEMENT

Not Applicable.

### REFERENCE TO A “SEQUENCE LISTING”, A TABLE, OR A COMPUTER PROGRAM

Not Applicable.

### BACKGROUND

1. Technical Field

Exemplary embodiments disclosed herein relate to separation of coins from a stream of refuse and/or recycle material.

The normal operating condition of an optical sorter for coins mixed into a refuse stream is to have material pass through a machine where a camera will take an image. A computer will decipher the image by comparing it to a set of preselected colors. When a color is matched it will eject the material (by use of compressed air valves) or let it pass through depending on the system is set up.

### BRIEF SUMMARY

The automated process, system and apparatus disclosed recognizes, and pulls or removes coins and/or currency from a stream of refuse and/or recycle material, such as, “3 mix” material (trash with heavy glass content).

### BRIEF DESCRIPTION OF THE FIGURES

The exemplary embodiments may be better understood, and numerous objects, features, and advantages made apparent to those skilled in the art by referencing the accompanying drawings. These drawings are used to illustrate only exemplary embodiments, and are not to be considered limiting of its scope, for the disclosure may admit to other equally effective exemplary embodiments. The figures are not necessarily to scale and certain features and certain views of the figures may be shown exaggerated in scale or in schematic in the interest of clarity and conciseness.

FIG. 1 depicts an exemplary embodiment of a coin and/or currency selection tool and removal system.

FIG. 2 depicts an exemplary embodiment of assorted material.

FIG. 3 depicts an exemplary embodiment of selected coins and/or currency.

FIG. 4 depicts an exemplary embodiment of separated assorted material, including nonferrous metals.

FIG. 5 depicts an exemplary embodiment of a block diagram of a computer, computing unit, processor and/or program modified sorter system.

### DETAILED DESCRIPTION OF THE EXEMPLARY EMBODIMENT(S)

The description that follows includes exemplary apparatus, methods, techniques, and instruction sequences that embody techniques of the inventive subject matter. However, it is understood that the described exemplary embodiments may be practiced without these specific details.

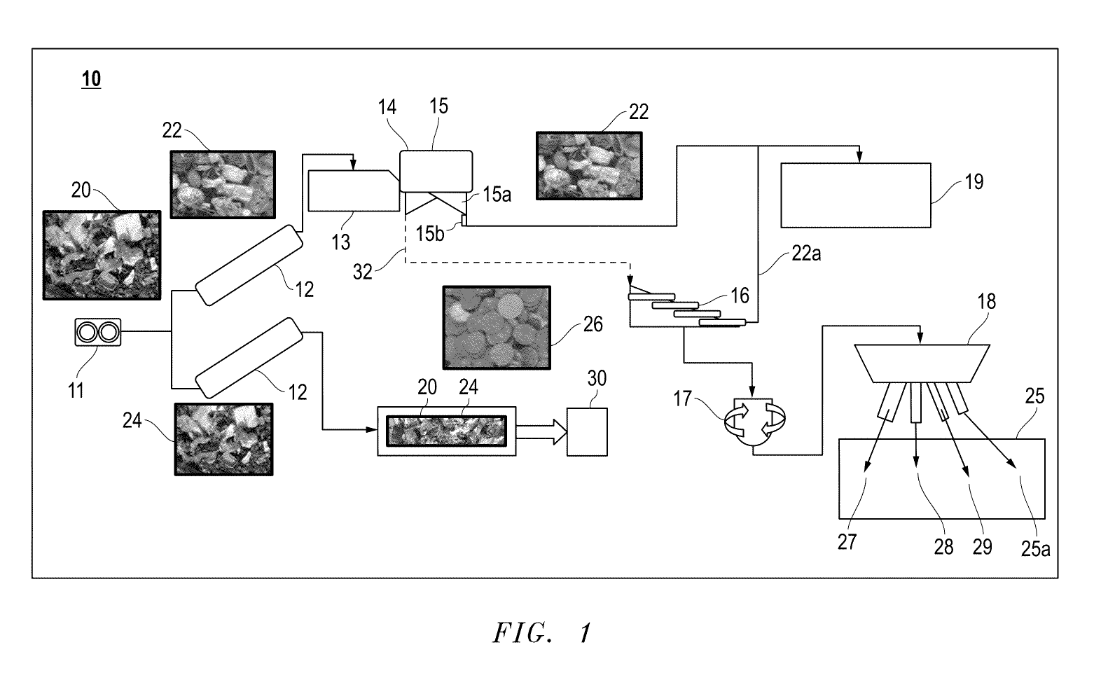

FIG. 1 depicts an exemplary embodiment of a currency selection tool and system 10. In one working example, the operating condition of an optical sorter 15 is to have material 20 (including a volume of assorted material 20 which may contain refuse and/or recycle materials, e.g., nonferrous metals or materials 22 and coins and currency 25 and/or “3 mix material”, such as trash with heavy glass content) pass through the optical sorter machine 15 where a camera 15a (or the like) will take an image. The computer, computing unit, processor and/or program modified sorter 14 will decipher the image. When a match is made the system 10 will eject the recognized material (by use of compressed air valves 15b) or let it pass through (optionally with other ejection means 15b) depending on the system 10 is arranged.

The disclosed exemplary embodiments of the currency selection tool and system 10 may use equipment with a program, processor, computer and/or computing unit addition 14 that allows sorting by material 20 (including coins and currency 25 etc.) by its shape 21 instead of or in addition to color. Sorting coins from a stream of refuse and/or recycle materials by shape and/or size 21 has not previously been utilized, although there is a need for improved automated sorting equipment and processing. Color sorting has been the primary concern in the prior food and recycling industry. In the disclosed embodiments, the computer, computing unit, processor and/or program modified sorter 14 will decipher the image from the camera 15a by comparing it to a set of preselected shapes and/or sizes 21. Shape and/or size 21 imaging may, for example, but not limited to, factor in length, width and/or height, perimeter and/or thickness, including in perspective, and/or contrast with surrounding shape and/or size or existing data. When a shape and/or size 21 is matched it will separate and eject the selected material 26 (by use of compressed air valves 15b) or let it pass through (optionally with other downstream ejection means 15b).

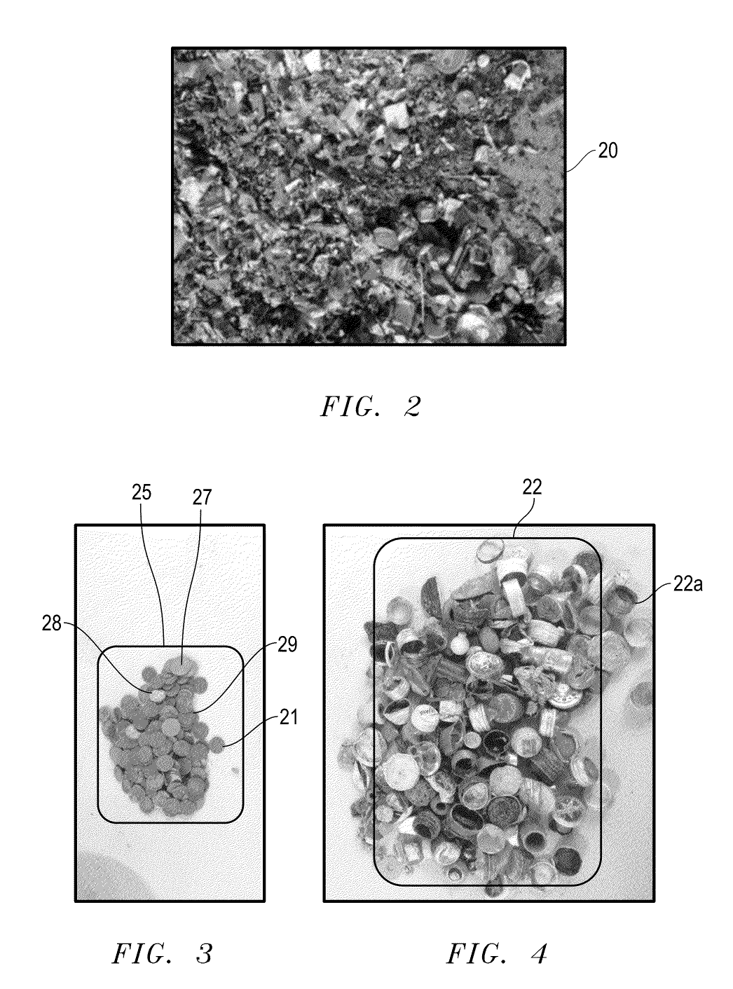

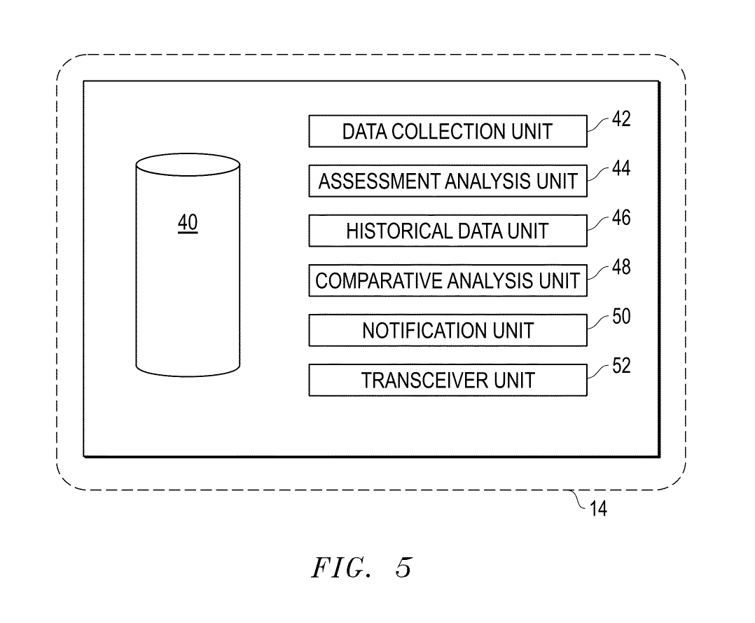

Utilizing an eddy current 11 the nonferrous material or metal 22 is pulled out of the assorted materials, such as, for example, “3 mix”, trash or glass stream 20, and transported via a conveyor 12, to vibratory medium or table 13, and then to an optical sorter 15, where it runs through the optical sorter 15. The shape and/or size selected (recognized) material 26 will be kicked from the nonferrous stream 22 to a line of kicked coins and/or currency 32 feeding to finger screen or finger deck screener 16 where the fugitive kicked nonferrous material 22a (which may still be in the volume of shape size selected material 26) is separated from the coins and currency 25. The nonferrous material or metals 22 and fugitive kicked nonferrous material or metals 22a are subsequently transported to a nonferrous metal collection bin 19. FIG. 2 depicts material 20 (including a volume of assorted material 20 which may contain refuse and/or recycle materials, e.g., nonferrous metals or materials 22 and coins and currency 25 and/or “3 mix material”, such as trash with heavy glass content. FIG. 3 depicts selected coins and currency 25 and FIG. 4 depicts separated nonferrous material or metals 22.

The ferrous material 24 is removed from the stream and using a conveyor 12, is transported to a glass recovery process and system 30 for subsequent processing.

The coins and currency 25 then go to a vibrating medium 17 (such as a tumbler) where they are cleaned. After the cleaning, the coins and currency 25 are run through an industrial coin sorter 18, which may sort the coins and currency 25 into quarters 27, nickels 28, dimes 29, amongst other coins and currency 25a.

FIG. 5 depicts a schematic view of the computer, computing unit, processor and/or program modified sorter 14 according to an embodiment. The computer, computing unit, processor and/or program modified sorter 14 may have, by way of example only, one or more of, a storage device 40, a data collection unit 42, an assessment analysis unit 44, a historical data unit 46, a comparative analysis unit 48, a notification unit 50, and a transceiver unit 52. The storage device 40 may be any suitable storage device for storing data. The transceiver unit 52 may be any suitable device configured to send and/or receive data to the optical sorter 15, to a local control site or remotely.

The data collection unit 42 may collect, manipulate, and/or categorize the data collected by the camera/digital camera 15a, and/or input of the material 20. The data collected may include any real time details. Further, the data collected may be any suitable data that can be collected from any suitable camera/digital camera/sensor 15a. The data collection unit 42 may manipulate the collected data into a desired format that allows the system 10 to take appropriate action during the operations as discussed herein.

The assessment analysis unit 44 may receive the categorized data from the data collection unit 42 in order to tabulate and/or determine factors such shapes and/or sizes 21, optionally color, etc. The shapes and/or sizes 21, optionally color, etc. may be based on real time events that are taking place in the operations and/or based on predictive events that are likely to occur. The assessment analysis unit 44 may classify the shapes and/or sizes 21, optionally color, etc.

The historical data unit 46 may categorize the historical data collected by the data collection unit 42. Further, the historical data unit 46 may categorize historical known data such as that of preselected shapes and/or sizes or data of “3 mix”, trash or glass stream 20, nonferrous stream 22, optionally color, etc.

The comparative analysis unit 48 may compare the data collected by the data collection unit 42, shapes and/or sizes 21, optionally color, preselected shapes and/or sizes and/or the historical data in order to determine a course of action for any compressed air valves or other ejection means 15b, or operator. The comparative analysis unit 48 may further determine if shapes and/or sizes 21 (and optionally color) are within a predetermined set of parameters. The parameters may be any suitable parameters set by the preselected shapes and/or sizes, optionally color, operator or any other suitable source. The comparative analysis unit 48 may make a determination of whether to activate compressed air valves or other ejection means 15b based on the data collected. The comparative analysis unit 48 may relay information to the notification unit 50 so that the notification unit 50 may alert any operator and/or take action. The comparative analysis unit 48 may use algorithm(s) developed to approximate or predict appropriate or desirable sorting.

The optional notification unit 50 may alert any operator of a real time condition, and/or a predicted condition about the system 10. The notification unit 50 may alert the operator via a discrete alarm, a visual display, an audible sound (such as an alarm), a kinetic or automated response, and/or a combination thereof. The notification unit 50 may transmit an alarm to a remote facility (such as the service company) via a communication network(s). The notification unit 50 may create or enable an implementation plan. The implementation plan may include, but is not limited to recovery plans and schedules, maintenance plans and schedules, mitigation plans and schedules for any of the components of the system 10. Further, the notification unit 50 may take preventative action to prevent further risk to the system 10 and/or personnel.

While the exemplary embodiments are described with reference to various implementations and exploitations, it will be understood that these exemplary embodiments are illustrative and that the scope of the inventive subject matter is not limited to them. Many variations, modifications, additions and improvements are possible.

Plural instances may be provided for components, operations or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

1. An apparatus tool for selecting a currency from a volume of assorted material, comprising:
an eddy current, wherein the eddy current has a means for separating a nonferrous material from the volume of assorted material;
an optical sorter in communication with the eddy current, wherein the optical sorter has a means for receiving the nonferrous material, wherein the optical sorter comprises:
a camera having a means for capturing an image of the nonferrous material;
a processor having a means for selecting a shape of the nonferrous material based on the image; and
a compressed air valve having a means for ejecting a volume of shape sized selected material; and
a finger deck screener in communication with the optical sorter and wherein the finger deck screener has a means for receiving the volume of shape sized selected material and separate a volume of fugitive kicked nonferrous material from the currency;
a vibrating medium having a means for receiving the currency; and
a coin sorter.

2. The apparatus according to claim 1, wherein the processor comprises:
a data collection unit having a means for collecting data from the camera; and
a comparative analysis unit having a means to compare the data collected by the data collection unit of a shape of a material and a preselected shape of a material.

3. The apparatus according to claim 2, further comprising:
a storage device unit configured to store data collected from the data collection unit;
a historical data unit configured to categorize historical data from the data collection unit and the storage device unit;
an assessment analysis unit having a means for receiving data from the data collection unit and a means for determining factors such the shape.

4. The apparatus according to claim 3 further comprising a transceiver unit having a means for sending and receiving data from the optical sorter.

5. A method for selecting a volume of currency from a volume of assorted material, comprising the steps of:
separating a volume of nonferrous metals from the volume of assorted material;
imaging the volume of nonferrous metals into an image;
separating the volume of nonferrous metals based on a shape in the image into a volume of shape sized selected material;
removing a volume of fugitive kicked nonferrous metal from the volume of shape sized selected material; and further separating the volume of shape sized selected material into the volume of currency;
cleaning the volume of currency; and
sorting the volume of currency.

6. A method for recognizing and removing a plurality of coins from a stream of refuse and/or recycle material, comprising the steps of:
imaging the stream; and
recognizing the plurality of coins by shape.

7. The method according to claim 6 further comprising the step of removing the recognized plurality of coins from the stream.

8. The method according to claim 6, further comprising the step of recognizing the plurality of coins by size.

9. The method according to claim 6, further comprising the step of comparing the plurality of coins recognized by shape to a set of preselected shapes.

10. The method according to claim 8, further comprising the step of comparing the plurality of coins recognized by shape to a set of preselected shapes.

11. The method according to claim 10, further comprising the step of comparing the plurality of coins recognized by size to a set of preselected sizes.
